(19) United States
(12) Patent Application Publication
(10) Pub. No.: US 2012/0167916 A1
(43) Pub. Date: Jul. 5, 2012

(54) NEUTRALIZING/REDUCING AGENT, AND DESMEAR METHOD

(75) Inventors: Yoshikazu Saijo, Hirakata-shi (JP); Hisamitsu Yamamoto, Hirakata-shi (JP); Masayuki Utsumi, Hirakata-shi (JP)

(73) Assignee: C. UYEMURA & CO., LTD., Osaka-shi, Osaka (JP)

(21) Appl. No.: 13/395,201

(22) PCT Filed: Sep. 24, 2010
(86) PCT No.: PCT/JP2010/066489

§ 371 Date: Mar. 9, 2012

(30) Foreign Application Priority Data
Oct. 8, 2009 (JP) 2009-234030

(51) Int. Cl. B08B 3/08; C11D 7/60

(52) U.S. Cl. 134/2; 510/175

(57) ABSTRACT

Disclosed is a neutralizing/reducing agent for neutralizing/reducing an oxidizing agent component that is adsorbed and remains on an object to be coated after the object is subjected to a desmear treatment with the oxidizing agent, which comprises a thioamide compound and a non-aromatic thiol compound. The neutralizing/reducing agent does not generate any gas during a neutralization/reduction treatment, and therefore the occurrence of defects caused by the neutralization/reduction on the surface of a through hole or a blind via hole can be prevented. Further, the neutralizing/reducing agent hardly dissolves copper, and therefore the occurrence of haloing can be prevented, and the blistering caused by the etching between an inner layer copper and a resin with the neutralizing/reducing agent can also be prevented.

### TECHNICAL FIELD

This invention relates to a neutralizing/reducing agent for neutralizing/reducing oxidizing agent components (manganate compound etc.) adsorbed on a substrate in a desmear step such as of a printed circuit board and removing them by dissolution and also to a desmear method.

### BACKGROUND ART

When through-holes or blind via holes of a printed circuit board are formed, there is developed a smear, which is resin accretion, owing to the heat of friction between a drill or laser and a resin. In order to ensure electric characteristics of the through-hole or blind via hole, a desmear step is essential for removing the smear developed on the through-hole or blind via hole, for which usual practice is to adopt smear removal by a chemical technique. The most general chemical method makes use, as an oxidizing agent, of a permanganate such as sodium permanganate or potassium permanganate so as to remove smear by dissolution. The manganate compound formed by adsorption on a substrate after the treatment with these permangnates has to be removed by neutralization and reduction.

As a conventional neutralizing/reducing agent, hydroxylamine compounds or hydrazine compounds have been hitherto used. In Japanese Patent No. 3776198 (Patent Document 1), there is described a neutralizing/reducing agent containing polyoxyethylene monoallyl monomethyl ether/maleic anhydride/styrene copolymer. However, treatment with the existing neutralizing/reducing agents results in the generation of gas. This is considered for the reason that a hydroxyamine compound or hydrazine compound and an oxidizing agent are reacted thereby generating nitrogen gas or hydrogen gas. If such a gas is accumulated in the through-hole or blind via hole, neutralization/reduction failure takes place, thereby presenting a problem in that copper does not deposit in a subsequent plating step.

Further, when an ordinary multilayered printed circuit board wherein a copper layer and a resin layer are alternately laminated is formed therein with a through-hole or blind via hole, the copper layer is exposed at the inner surface of the hole. This copper layer is dissolved when using the conventional neutralizing/reducing agent, so that interspace occurs between the copper layer and the resin layer (haloing). When copper plating is carried out under conditions of haloing being developed, the interspace between the resin and copper layers is blocked, thereby forming a closed void. The air and moisture in the void formed in this manner is expanded by heating in a subsequent step, thereby causing a blister. The blister will break a plated film and cause a problem of conduction failure of the printed circuit board.

### SUMMARY OF THE INVENTION

### Problems to be Solved by the Invention

The invention has been made to solve the above problems and has for its object the provision of a neutralizing/reducing agent that does not generate a gas when an oxidizing agent component (such as a manganate compound) adsorbed on a substrate is neutralized/reduced and removed by dissolution in a desmear step and does not dissolve copper, and also a desmear method wherein the oxidizing agent component is neutralized/reduced with the neutralizing/reducing agent.

### Means for Solving the Problems

The present inventors have made intensive studies so as to solve these problems and, as a result, found that in a desmear step of treating an object to be plated, such as a printed circuit board, with an oxidizing agent, when the object to be plated is subjected to neutralizing/reducing treatment with a neutralizing/reducing agent containing a thioamide compound and a non-aromatic thiol compound after the desmear treatment, no gas generates and copper is hardly dissolved, and no failure such as of non-plating defect occurs in subsequent copper plating on a through-hole or blind via hole and blisters caused by heating are suppressed from occurring, thereby arriving at completion of the invention.

Accordingly, the invention provides the following neutralizing/reducing agent and desmear method.

### Claim 1:

A neutralizing/reducing agent for neutralizing/reducing an oxidizing agent component that is adsorbed and remains on an object to be plated after the object to be plated has been subjected to desmear treatment with an oxidizing agent, characterized by including a thioamide compound and a non-aromatic thiol compound.

### Claim 2:

The neutralizing/reducing agent as defined in claim 1, characterized in that the thioamide compound is one or two or more compounds selected from thiourea, dimethylthiourea, diethylthiourea, trimethylthiourea, acetylthiourea, allylthiourea, ethylenethiourea, thiosemicarbazide and tetramethylthiourea, and the non-aromatic thiol compound is one or two or more compounds selected from 2-mercapto ethanol, methyl mercaptan, ethyl mercaptan, butyl mercaptan, n-octyl mercaptan, n-dodecyl mercaptan, t-dodecyl mercaptan, hexadecyl mercaptan, mercaptoacetic acid, mercaptosuccinic acid, mercaptolactic acid and water-soluble salts thereof.

### Claim 3:

The neutralizing/reducing agent as defined in claim 1 or 2, characterized by further including at least one selected from an inorganic acid and an organic acid.

### Claim 4:

The neutralizing/reducing agent as defined in any one of claims 1 to 3, characterized in that the pH is up to 4.

### Claim 5:

The neutralizing/reducing agent as defined in any one of claims 1 to 4, characterized in that the oxidizing agent is a permanganate.

### Claim 6:

The neutralizing/reducing agent as defined in any one of claims 1 to 5, characterized in that the object to be plated is a printed circuit board having a through-hole or blind vial hole.

### Claim 7:

A desmear method, characterized by including, after subjecting an object to be plated to desmear removal treatment, neutralizing/reducing an oxidizing agent component adsorbed and remaining on the object to be plated with the neutralizing/reducing agent defined in any one of claims 1 to 6.

### Advantageous Effect of the Invention

According to the neutralizing/reducing agent of the invention, no gas generates in the course of the neutralizing/reducing treatment, so that neutralization/reduction failure does not occur on the surfaces of a through-hole or blind via hole. Because copper is hardly dissolved, haloing is suppressed from occurring with no development of blisters as will be caused by etching with the neutralizing/reducing agent between an inner layer copper and a resin.

### EMBODIMENT FOR CARRYING OUT THE INVENTION

The invention is now described in detail.

The neutralizing/reducing agent of the invention is a solution containing a thioamide compound and a non-aromatic thiol compound.

The thioamide compounds used may be known ones. More particularly, mention is made of thiourea, dimethylthiourea, diethylthiourea, trimethylthiourea, acetylthiourea, allylthiourea, ethylene thiourea, thiosemicarbazide, tetramethylthiourea and the like. These may be used singly or in combination of two or more.

The concentration of a thioamide compound in the neutralizing/reducing agent is preferably at 1 to 300 g/L, more preferably at 3 to 100 g/L. If the concentration of the thioamide is too low, there is concern that neutralization/reduction does not proceed satisfactorily. On the other hand, too a high concentration of the thioamide compound is poor in economy.

The non-aromatic thiol compounds used may be known ones. More particularly, mention is made of 2-mercaptoethanol, methyl mercaptan, ethyl mercaptan, butyl mercaptan, n-octyl mercaptan, n-dodecyl mercaptan, t-dodecyl mercaptan, hexadecyl mercaptan, mercaptoacetic acid, mercaptosuccinic acid, mercaptolactic acid and water-soluble salts thereof. These may be used singly or in combination of two or more.

The concentration of the non-aromatic thiol compound is preferably at 1 to 300 g/L, more preferably at 3 to 100 g/L. If the concentration of the non-aromatic thiol compound is too low, there is concern that that neutralization/reduction does not proceed satisfactorily. On the other hand, too high a concentration of the non-aromatic thiol compound is poor in economy.

In the neutralizing/reducing agent of the invention, the thioamide compound and non-aromatic thiol compound are both essential. If only one of them is used, precipitation takes place after neutralizing/reducing treatment and thus, an impurity results in a subsequent plating step, thereby giving an adverse influence thereon.

The neutralizing/reducing agent of the invention should preferably contain at least one selected from inorganic acids and organic acids. The inorganic acid and organic acids include sulfuric acid, hydrochloric acid, nitric acid, phosphoric acid, hydrofluoric acid, fluoroboric acid, sulfamic acid, organic sulfonic acids, carboxylic acids (fatty saturated carboxylic acids, aromatic carboxylic acids and aminocarboxylic acids), condensed phosphoric acids, phosphonic acid, water-soluble salts of these acids and lactone compounds. The carboxylic acids are preferably free of a mercapto group.

The concentration of the inorganic acid and organic acid is preferably at 1 to 300 g/L, more preferably at 3 to 100 g/L. If the concentration of the inorganic acid and organic acid is too low, there is concern that neutralization/reduction does not proceed satisfactorily. On the other hand, too high a concentration of the inorganic acid and organic acid is poor in economy.

The neutralizing/reducing agent of the invention is preferably acidic and more preferably has a pH of at least 4. If the pH exceeds 4, there is concern that neutralization/reduction does not proceeds satisfactorily.

The neutralizing/reducing agent of the invention is one that is used to neutralize/reduce oxidizing agent components (an oxidizing agent and a component derived from the oxidizing agent) adsorbed and remaining on an object to be plated after the desmear treatment, with an oxidizing agent, of the object to be plated such as a printed circuit board including a multi-layered printed circuit board alternately laminating a copper layer and a resin layer, particularly, a printed circuit board having a though-hole or blind via hole. This neutralizing/reducing agent is suited for neutralizing/reducing the oxidizing agent components adsorbed and left on the object to be plated after the desmear treatment of the object to be plated with the oxidizing agent. In doing so, no gas generates in the course of the neutralizing/reducing treatment, so that neutralization/reduction failure does not occur on the surface of the through-hole or blind via. Since copper is hardly dissolved, the treatment can be carried out without causing problems such as of haloing and blisters.

The oxidizing agents used may be known ones and include, for example, permanganates such as sodium permanganate and potassium permanganate. If a permanganate is used as the oxidizing agent, a permanganate compound and a manganate compound are adsorbed and remain on an object to be plated as an oxidizing agent component. The neutralizing/reducing agent of the invention is particularly effective for the neutralization/reduction of these oxidizing agent components.

The neutralizing/reducing treatment temperature is preferably at 10 to 70° C., more preferably at 15 to 60° C. Too low a treatment temperature may not permit the neutralization/reduction to proceed satisfactorily. On the other hand, too high a treatment temperature is poor in economy. The treatment time for which the neutralizing/reducing treatment is carried out with use of the neutralizing/reducing agent of the invention is preferably at one to twenty minutes, more preferably at two to ten minutes. Too short a treatment time may permit the neutralization/reduction to proceed satisfactorily. On the hand, too long a treatment time is poor in economy.

### EXAMPLES

The invention is particularly described by way of Examples and Comparative Examples and should not be construed as limited to the following Examples.

### Examples 1 to 4, Comparative Examples 1 to 3

Using a substrate (10 cm in length×10 cm in width) wherein 100 blind via holes having a diameter of 50 μm were made in a substrate having an ordinary insulating resin (ABF-GX13, made by Ajinomoto Fine-Techno Co., Inc.) laminated on a printed circuit board FR-4 having a copper layer as an inner layer, this substrate was swollen in a swelling solution (MDS-37, made by C. Uyemura & Co., Ltd.) at 70° C. for ten minutes, followed by desmear treatment with a permanganate-containing resin etching solution (DES-502, made by C. Uyemura & Co., Ltd.) at 70° C. for 15 minutes. Next, using the respective neutralizing/reducing agents indicated in Table 1 below, neutralizing/reducing treatment was carried at 30° C. for five minutes and the number of blind via holes having a black residue left therein was counted to judge a neutralization/reduction failure of manganic acid. The state where the black residue was left means neutralization/reduction failure. Using a substrate whose opposite surfaces were copper plated, the weights prior to and after the neutralizing/reducing treatment were measured to calculate a dissolved film thickness of copper. Moreover, the presence or absence of precipitation occurring after the neutralizing/reducing treatment was observed. The results are also shown in Table 1.

TABLE 1

| | | | | | | Ratio of blind | Dissolved | Precipitation |
|---|---|---|---|---|---|---|---|---|
| | | | | | | via holes having | film | occurring after |
| | | | | | | residue left | thickness | neutralizing/ |
| | | | | | | therein (observed | of copper | reducing |
| | | Neutralizing/reducing agent | | | pH | holes: 100) | (μm) | treatment |
| Example | 1 | Thiourea | Mercapto- | Sulfuric acid | 1.5 | 0/100 | 0.11 | No |
| | | 20 g/L | succinic acid | 5 g/L | | | | |
| | | | 10 g/L | | | | | |
| | 2 | Dimethylthiourea | Mercapto- | Phosphoric acid | 2.0 | 0/100 | 0.13 | No |
| | | 20 g/L | acetic acid | 10 g/L | | | | |
| | | | 10 g/L | | | | | |
| | 3 | Allylthiourea | Mercapto- | Methane- | 1.0 | 0/100 | 0.15 | No |
| | | 20 g/L | lactic acid | sulfonic acid | | | | |
| | | | 10 g/L | 10 g/L | | | | |
| | 4 | Thiourea | Butylmercaptan | Sulfuric acid | 1.6 | 0/100 | 0.12 | No |
| | | 20 g/L | 10 g/L | 5 g/L | | | | |
| Comparative | 1 | Hydroxyl | — | Sulfuric acid | 1.6 | 4/100 | 1.54 | No |
| Example | | ammonium sulfate | | 5 g/L | | | | |
| | | 50 g/L | | | | | | |
| | 2 | Thiourea | — | Sulfuric acid | 1.5 | 0/100 | 0.10 | Yes |
| | | 20 g/L | | 5 g/L | | | | |
| | 3 | — | Mercapto- | Sulfuric acid | 1.5 | 0/100 | 0.12 | Yes |
| | | | succinic acid | 5 g/L | | | | |
| | | | 10 g/L | | | | | |

1. A neutralizing/reducing agent for neutralizing/reducing an oxidizing agent component that is adsorbed and remains on an object to be plated after the object to be plated has been subjected to desmear treatment with an oxidizing agent, characterized by comprising a thioamide compound and a non-aromatic thiol compound.

2. The neutralizing/reducing agent as defined in claim 1, characterized in that the thioamide compound is one or two or more compounds selected from thiourea, dimethylthiourea, diethylthiourea, trimethylthiourea, acetylthiourea, allylthiourea, ethylenethiourea, thiosemicarbazide and tetramethylthiourea, and the non-aromatic thiol compound is one or two or more compounds selected from 2-mercapto ethanol, methyl mercaptan, ethyl mercaptan, butyl mercaptan, n-octyl mercaptan, n-dodecyl mercaptan, t-dodecyl mercaptan, hexadecyl mercaptan, mercaptoacetic acid, mercaptosuccinic acid, mercaptolactic acid and water-soluble salts thereof.

3. The neutralizing/reducing agent as defined in claim 1, characterized by further comprising at least one selected from an inorganic acid and an organic acid.

4. The neutralizing/reducing agent as defined in claim 1, characterized in that the pH is up to 4.

5. The neutralizing/reducing agent as defined in claim 1, characterized in that the oxidizing agent is a permanganate.

6. The neutralizing/reducing agent as defined in claim 1, characterized in that the object to be plated is a printed circuit board having a through-hole or blind vial hole.

7. A desmear method, characterized by comprising, after subjecting an object to be plated to desmear removal treatment, neutralizing/reducing an oxidizing agent component adsorbed and remaining on the object to be plated with the neutralizing/reducing agent defined in claim 1.
